(19) United States
(12) Patent Application Publication
(10) Pub. No.: US 2025/0160260 A1
(43) Pub. Date: May 22, 2025

(54) FORESTRY MULCHING ROTARY CUTTING DEVICE

(71) Applicant: QUADCO INC., Saint-Eustache, Quebec (CA)

(72) Inventors: Charles HENRICHON, Saint-Eustache, Quebec (CA); Etienne MINVILLE, Saint-Eustache, Quebec (CA)

(21) Appl. No.: 18/841,016

(22) PCT Filed: Feb. 23, 2023
(86) PCT No.: PCT/CA2023/050224

§ 371 Date: Aug. 23, 2024

Related U.S. Application Data
(60) Provisional application No. 63/268,401, filed on Feb. 23, 2022.

(51) Int. Cl. A01G 3/00; A01G 23/06

(52) U.S. Cl. CPC A01G 3/002; A01G 23/067

(57) ABSTRACT

A mulcher head comprises a frame and a culling drum rotationally connected to the frame. The cutting drum comprises a plurality of tool holders each configured to receive one of a plurality of culler or culling tools with at least one edge for shredding the material, and a bite limiter assembly operatively coupled to the outer surface of the tubular body. The bite limiter assembly comprises at least one guide plate coupled to the tubular body at an angle to a rotational axis of the culling drum. The bite limiter assembly is configured to restrict engagement of each of the plurality of cutting tools with the material. A culling drum is also provided. The tool holders may comprise a recess and a wedge, the culling tools being removably coupled to a corresponding tool holder with an interference fit between each of the culling tools and the wedge.

### TECHNICAL FIELD

This disclosure generally relates to mulcher and mower heads and cutting drums thereof. Specifically, this disclosure relates to cutting drums having guide plates for controlling the depth of engagement of the cutting tools.

### BACKGROUND

Cutting heads or mulcher heads comprising a rotating drum with cutting teeth are used to shred, cut or size reduce a material. As the rotating drum rotates, the cutting teeth dig into the material at variable depths, which can cause stalling or jams if the cutting teeth dig into the material too deeply. Some rotating drums include rings welded around the rotating drum adjacent or close to the cutting teeth to reduce the surface area of the material that the cutting teeth have access to. However, the rings are welded around the rotating drum radially in a configuration that is perpendicular to an axis of the rotating drum and thus require a significant number of rings and welding joints along the rotating drum.

In view of the above, there is a need for more cost effective and efficient devices that would be able to overcome or at least minimize some of the above-discussed prior art concerns.

### SUMMARY

It is therefore an aim of the present invention to address the above mentioned issues.

According to a general aspect, there is provided a mulcher head for shredding a material. A mulcher head can also be referred to as a mower head. The mulcher head comprises: a frame; a cutting drum rotationally connected to the frame, wherein the cutting drum comprises; a tubular body having an axial center, a first side and a second side; a plurality of tool holders each configured to receive one of a plurality of cutter tools with at least one edge for shredding the material, the plurality of tool holders operatively coupled to an outer surface of the tubular body; and a bite limiter assembly operatively coupled to the outer surface of the tubular body; wherein the bite limiter assembly is coupled to the tubular body in a helix configuration; wherein a cutting radius extending from an axis of the cutting drum to a cutting edge of the plurality of cutting tools is greater than a guide radius extending from the axis to an exterior edge of the bite limiter assembly, such that the bite limiter assembly is configured to restrict engagement of each of the plurality of cutting tools with the material.

In some embodiments, the bite limiter assembly comprises at least two guide plates that form a double helix.

In some embodiments, the double helix is a congruent double helix.

In some embodiments, at least two adjacent ones of the plurality of tool holders are coupled to the tubular body offset from each other.

In some embodiments, the at least two adjacent ones of the plurality of tool holders are offset from each other by between about 5° and about 85°.

In some embodiments, the at least two adjacent ones of the plurality of tool holders are offset from each other by between about 40° and about 80°.

In some embodiments, the plurality of tool holders are coupled to the tubular body in a tool helix configuration.

In some embodiments, the tool helix configuration is a double helix.

In some embodiments, the helix configuration of the at least two guide plates and the tool helix configuration have a pitch and a chirality that is substantially the same.

In some embodiments, the bite limiter assembly comprises a first guide plate and a second guide plate forming a first double helix on the first side of the tubular body and a third guide plate and a fourth guide plate forming a second double helix on the second side of the tubular body.

In some embodiments, the mulcher head further comprises a first connection plate and a second connection plate, wherein the first guide plate and the third guide plate are coupled at respective ends thereof to the first connection plate and the second guide plate and the fourth guide plate are coupled at respective ends thereof to the second connection plate.

In some embodiments, a first chirality of the first double helix is the opposite to a second chirality of the second double helix.

In some embodiments, at least two of the plurality of tool holders at the center of the tubular body are side by side in a substantially similar axial plane.

In some embodiments, the first chirality and the second chirality are configured to direct a shredded material to the center of the cutting drum.

In some embodiments, the first chirality is configured to direct a shredded material to the first side of the cutting drum and the second chirality is configured to direct the shredded material to the second side of the cutting drum.

In some embodiments, the bite limiter assembly is coupled to the outer surface of the cutting drum between adjacent ones of the plurality of teeth holders.

In some embodiments, the bite limiter assembly is coupled to a non-cutting edge side of the plurality of tool holders.

In some embodiments, the bite limiter assembly is coupled to the cutting drum on the outer surface adjacent to a non-cutting edge side of the plurality of cutting tools.

In some embodiments, opposing pairs of the plurality of tool holders on opposing sides of the tubular body are in a substantially similar axial plane.

In some embodiments, the mulcher head further comprises a plurality of cutter tools, wherein each of the plurality of cutter tools are configured to couple to one of the plurality of tool holders.

In some embodiments, the mulcher head further comprises a motor operatively connected to the cutting drum and configured to drive rotation thereof.

In some embodiments, the cutting drum further comprises a first mounting plate coupled to the tubular body on the first side and a second mounting plate coupled to the tubular body on the second side, the first mounting plate having a first coupling interface for operatively connecting with a first rotational shaft and the second mounting plate having a second coupling interface for operatively connecting with a second rotational shaft.

In some embodiments, a first axial distance between the axial center and the first mounting plate is larger than a second axial distance between the axial center and the second mounting plate.

In some embodiments, the second axial distance is between about 20% and about 70% shorter than the first axial distance.

In some embodiments, the second mounting plate is coupled to an interior wall of the tubular body between the axial center and a second end of the tubular body on the second side to create a cavity within a hollow interior of the tubular body.

In some embodiments, the mulcher head further comprises a motor operatively connected to one of the first rotational shaft and the second rotational shaft.

In some embodiments, the motor is configured to at least partially fit in the cavity.

In some embodiments, the motor is operatively connected to the second rotational shaft with a bearing.

In some embodiments, the mulcher head further comprises a mounting flange operatively coupled to the second rotational shaft in the cavity for securing the motor in the cavity.

In some embodiments, the mulcher head further comprises a debris guard.

In some embodiments, the tubular body comprises a first groove on a first end of the first side and a second groove on a second end of the second side.

In some embodiments, the debris guard comprises a first grooved plate coupled to the frame adjacent to the first end of the tubular body and a second grooved plate coupled to the frame adjacent to the second end of the tubular body, wherein the first grooved plate and the second grooved plate each comprise a groove and a protrusion, and wherein the first groove is configured to receive the protrusion of the first grooved plate and the second groove is configured to receive the protrusion of the second grooved plate.

In some embodiments, an inner diameter of the protrusion of the first grooved plate and the second grooved plate is larger than an exterior diameter of the first groove and the second groove.

In some embodiments, the debris guard further comprises a first ring coupled to the first mounting plate and a second ring coupled to the second mounting plate; wherein the first ring and the second ring each have an exterior ring diameter that is larger than an exterior diameter of the tubular body.

In some embodiments, an inner diameter of the groove of the first grooved plate and the second grooved plate is larger than the exterior ring diameter of the first ring and the second ring.

In some embodiments, an interior ring diameter of the first ring and the second ring is larger than an interior diameter of the tubular body.

In some embodiments, the mulcher head further comprises the plurality of cutter tools, wherein each of the plurality of cutter tools are configured to couple to a respective one of the plurality of tool holders.

In some embodiments, the plurality of cutter tools are coupled to the plurality of tool holders with at least one fastener.

In some embodiments, each of the plurality of cutter tools comprise an aperture configured to receive the at least one fastener therethrough and each of the plurality of tool holders comprises receiving means for receiving the aperture.

In some embodiments, each of the plurality of tool holders comprise a recess configured to receive one of the plurality of cutting tools and a wedge.

In some embodiments, each of the plurality of cutter tools are removably coupled to the plurality of tool holders with an interference fit between each of the plurality of cutter tools and the wedge.

In some embodiments, the wedge is coupled to a corresponding one of the plurality of tool holders with at least one wedge fastener.

In some embodiments, the mulcher head further comprises a washer or a lock washer to secure the at least one wedge fastener against the wedge.

In some embodiments, the plurality of tool holders further comprise a non-cylindrical aperture that is configured to receive at least one non-cylindrical body, wherein the at least one non-cylindrical body is engageable with the at least one wedge fastener.

In some embodiments, the at least one non-cylindrical body is a square or hexagonal nut.

In some embodiments, the wedge is a trapezoidal block.

In some embodiments, a cutting tangential path line extending from the cutting radius through the cutting edge of the plurality of cutting tools is at an angle with a guide tangential path line extending from the guide radius.

In some embodiments, the angle is between about 5° and about 45°.

In some embodiments, the angle is between about 20° and about 45°.

In some embodiments, the frame is mountable onto a movable working arm of a self-propelled vehicle.

In some embodiments, a helical angle of the helical configuration of the bite limiter assembly is between about 45° and about 85°.

In some embodiments, the helical angle is between about 60° and 80°.

In some embodiments, the helical angle is about 65°.

According to another aspect, there is provided a cutting drum configured to mount onto a frame for shredding a material, the cutting drum comprising: a tubular body having an axial center, a first side and a second side; a plurality of tool holders each configured to receive one of a plurality of cutter tools with at least one edge for shredding the material, the plurality of tool holders operatively coupled to an outer surface of the tubular body; and a bite limiter assembly operatively coupled to the outer surface of the tubular body; wherein the bite limiter assembly is coupled to the tubular body in a helix configuration; and wherein the bite guard assembly is configured to restrict a depth of engagement of each of the plurality of cutting tools with the material.

According to another aspect, there is provided a mulcher head for shredding a material, the mulcher head comprising: a frame; a cutting drum rotationally connected to the frame, wherein the cutting drum comprises; a tubular body having an axial center, a first side and a second side; a plurality of cutter tools with at least one edge for shredding the material; and a plurality of tool holders operatively coupled to an outer surface of the tubular body, wherein the plurality of tool holder each comprise: a recess configured to receive one of the plurality of cutting tools; and a wedge; wherein each of the plurality of cutter tools are removably coupled to a corresponding one of the plurality of tool holders with an interference fit between each of the plurality of cutter tools and the wedge.

In some embodiments, the wedge is coupled to the corresponding one of the plurality of tool holders with at least one wedge fastener.

In some embodiments, the mulcher head further comprises a washer or a lock washer to secure the at least one wedge fastener against the wedge.

In some embodiments, the plurality of tool holders further comprise a non-cylindrical aperture that is configured to receive at least one non-cylindrical body, wherein the at least one non-cylindrical body is engageable with the at least one wedge fastener.

In some embodiments, the at least one non-cylindrical body is a square or hexagonal nut.

In some embodiments, the wedge is a trapezoidal block.

In some embodiments, the mulcher head further comprises a bite limiter assembly operatively coupled to the outer surface of the tubular body.

In some embodiments, the bite limiter assembly is coupled to the outer surface in a single double helix formation.

In some embodiments, the bite limiter assembly comprises a first guide plate and a second guide plate forming a first double helix on the first side of the tubular body and a third guide plate and a fourth guide plate forming a second double helix on the second side of the tubular body.

In some embodiments, the mulcher head further comprises a first connection plate and a second connection plate, wherein the first guide plate and the third guide plate are coupled at respective ends thereof to the first connection plate and the second guide plate and the fourth guide plate are coupled at respective ends thereof to the second connection plate.

In some embodiments, a first chirality of the first double helix is the opposite to a second chirality of the second double helix.

In some embodiments, the first chirality and the second chirality are configured to direct a shredded material to the center of the cutting drum.

In some embodiments, the first chirality is configured to direct a shredded material to the first side of the cutting drum and the second chirality is configured to direct the shredded material to the second side of the cutting drum.

In some embodiments, a helical angle of the bite limiter assembly is between about 45° and about 85°.

In some embodiments, the helical angle is between about 60° and 80°.

In some embodiments, the helical angle is about 65°.

According to another aspect, there is provided a mulcher head for shredding a material, the mulcher head comprising: a frame; a cutting drum rotationally connected to the frame, wherein the cutting drum comprises; a tubular body having an axial center, a first side and a second side; a plurality of tool holders each configured to receive one of a plurality of cutter tools with at least one edge for shredding the material, the plurality of tool holders operatively coupled to an outer surface of the tubular body; and a bite limiter assembly operatively coupled to the outer surface of the tubular body; wherein the bite limiter assembly comprises at least one guide plate coupled to the tubular body at an angle to a rotational axis of the cutting drum; wherein a cutting radius extending from the axis of the cutting drum to a cutting edge of the plurality of cutting tools is greater than a guide radius extending from the axis to an exterior edge of the bite limiter assembly, such that the bite limiter assembly is configured to restrict engagement of each of the plurality of cutting tools with the material.

In some embodiments, the angle to the rotational axis is between about 5° and about 85°.

In some embodiments, the bite limiter assembly is coupled to the tubular body in a helix configuration, a double helix configuration, a congruent double helix, or an angled configuration.

In some embodiments, the angle to the rotational axis is a helical angle between about 45° and about 85°.

In some embodiments, at least two adjacent ones of the plurality of tool holders are coupled to the tubular body offset from each other by between about 5° and about 85°.

In some embodiments, the at least one guide plate and the plurality of tool holders are coupled to the tubular body with a pitch and a chirality that is substantially the same.

In some embodiments, the at least one guide plate comprises a plurality of first guide plates forming a first helix on the first side of the tubular body and a plurality of second guide plates forming a second helix on the second side of the tubular body.

In some embodiments, the plurality of first guide plates and the plurality of second guide plates each comprise at least one major guide plate and at least one minor guide plate.

In some embodiments, a first chirality of the first helix is the opposite to a second chirality of the second helix.

In some embodiments, the at least one guide plate further comprises a center guide plate coupled to the tubular body at or near the center axis substantially parallel with the center axis.

In some embodiments, the at least one guide plate is substantially straight.

In some embodiments, the bite limiter assembly comprises a first guide plate and a second guide plate forming a first double helix on the first side of the tubular body and a third guide plate and a fourth guide plate forming a second double helix on the second side of the tubular body.

In some embodiments, the at least one guide plate further comprises a first connection plate and a second connection plate, wherein the first guide plate and the third guide plate are coupled at respective ends thereof to the first connection plate and the second guide plate and the fourth guide plate are coupled at respective ends thereof to the second connection plate.

In some embodiments, a first chirality of the first double helix is the opposite to a second chirality of the second double helix.

In some embodiments, the at least one guide plate is configured to orient a shredded material one of: towards the first side of the cutting drum; towards the second side of the cutting drum; towards the axial center of the cutting drum; or toward the first side and the second side of the cutting drum.

In some embodiments, the bite limiter assembly is coupled to the outer surface of the cutting drum between adjacent ones of the plurality of teeth holders.

In some embodiments, the at least one guide plate is a plurality of guide plates and at least some of the plurality of tool holders are coupled to the outer surface of the cutting drum between abutting ones of the plurality of guide plates.

In some embodiments, a leading end of a respective one of the plurality of guide plates abuts a trailing side of a respective one of the plurality of tool holders and a trailing end of the respective one of the plurality of guide plates abuts a leading side of the respective one of the plurality of tool holders.

In some embodiments, the leading end of the respective one of the plurality of guide plates is tapered.

In some embodiments, the trailing end of the respective one of the plurality of guide plates comprises a debris recess configured to create a debris release area with a respective one of the plurality of cutting tools when fastened in the respective one of the plurality of tool holders.

In some embodiments, the cutting drum further comprises a first mounting plate coupled to the tubular body on the first side and a second mounting plate coupled to the tubular body on the second side, the first mounting plate having a first coupling interface for operatively connecting with a first rotational shaft and the second mounting plate having a second coupling interface for operatively connecting with a second rotational shaft.

In some embodiments, a first axial distance between the axial center and the first mounting plate is larger than a second axial distance between the axial center and the second mounting plate and wherein the second mounting plate is coupled to an interior wall of the tubular body between the axial center and a second end of the tubular body on the second side to create a cavity within a hollow interior of the tubular body.

In some embodiments, wherein the mulcher head further comprises a mounting flange operatively coupled to the second rotational shaft in the cavity for securing a motor in the cavity.

In some embodiments, the cutting drum further comprises a debris guard, the debris guard comprising a first groove on a first end of the first side and a second groove on a second end of the second side.

In some embodiments, the debris guard comprises a first grooved plate coupled to the frame adjacent to the first end of the tubular body and a second grooved plate coupled to the frame adjacent to the second end of the tubular body, wherein the first grooved plate and the second grooved plate each comprise a groove and a protrusion, and wherein the first groove is configured to receive the protrusion of the first grooved plate and the second groove is configured to receive the protrusion of the second grooved plate.

In some embodiments, an inner diameter of the protrusion of the first grooved plate and the second grooved plate is larger than an exterior diameter of the first groove and the second groove.

In some embodiments, the debris guard further comprises a first ring coupled to the first mounting plate and a second ring coupled to the second mounting plate; wherein the first ring and the second ring each have an exterior ring diameter that is larger than an exterior diameter of the tubular body.

In some embodiments, an inner diameter of the groove of the first grooved plate and the second grooved plate is larger than the exterior ring diameter of the first ring and the second ring.

In some embodiments, an interior ring diameter of the first ring and the second ring is larger than an interior diameter of the tubular body.

### BRIEF DESCRIPTION OF THE DRAWINGS

In order that the invention may be readily understood, embodiments of the invention are illustrated by way of example in the accompanying drawings.

FIG. 1 is a front view of a mulcher head according to one embodiment, showing a transparent frame shown in dash-dot lines and a cutting drum with a plurality of tool holders, a plurality of cutting tools, and a bite limiter assembly;

FIG. 2 is a front view the four guide plates shown in FIG. 1;

FIG. 3 is a side view of the mulcher head shown in FIG. 1;

FIG. 4A is a cross-sectional front view of the mulcher head shown in FIGS. 1 and 3 taken at line A-A in FIG. 3, showing a motor, bearing, and mounting flange housed internally within the cutting drum;

FIG. 4B is a cross-sectional front view of a mulcher head, according to another embodiment, wherein 2 motors are provided on each side of the drum;

FIG. 4C is an enlarged view of detail B shown in FIG. 4A, showing a debris guard;

FIG. 5 is a front view of a cutting drum according to another embodiment, showing a plurality of tool holders and a bite limiter assembly;

FIG. 6 is a front view of a cutting drum according to another embodiment, showing a bite limiter assembly;

FIG. 7 is a perspective front view of a cutting drum according to another embodiment, showing a plurality of tool holders, a plurality of cutting tools, and a bite limiter assembly;

FIG. 8 is a cross-sectional side view of the cutting drum shown in FIG. 7 taken at line B-B in FIG. 9;

FIG. 9 is a front view of the cutting drum shown in FIG. 7;

FIG. 10 is a front view of a mulcher head according to another embodiment, showing a transparent frame shown in dash-dot lines and a cutting drum with a plurality of tool holders, a plurality of cutting tools, and a bite limiter assembly;

FIG. 11A is a front view of a minor guide plate shown in the mulcher head of FIG. 10;

FIG. 11B is a front view of a major guide plate shown in the mulcher head of FIG. 10;

FIG. 11C is a front view of a major center guide plate shown in the mulcher head of FIG. 10;

FIG. 11D is a front view of a minor center guide plate shown in the mulcher head of FIG. 10;

FIG. 11E is a front view of a minor guide plate according to another embodiment;

FIG. 11F is a front view of a minor guide plate according to another embodiment;

FIG. 12 is a side view of the mulcher head shown in FIG. 10;

FIG. 13 is a cross-sectional front view of the mulcher head shown in FIGS. 10 and 12 taken at line A-A in FIG. 12;

FIG. 14 is a front view of a cutting drum according to another embodiment, showing a plurality of tool holders, a plurality of cutting tools, and a bite limiter assembly;

FIG. 15 is a front view of a cutting drum according to another embodiment, showing a plurality of tool holders, a plurality of cutting tools, and a bite limiter assembly;

FIG. 16A is a perspective front view of a cutting drum according to another embodiment, showing a plurality of tool holders, a plurality of cutting tools, and a bite limiter assembly;

FIG. 16B is a perspective expanded front view of the cutting drum shown in FIG. 16, showing a debris guard according to another embodiment;

FIG. 17 is a perspective assembled view of the cutting drum shown in FIG. 16B;

FIG. 17 is a side view of the cutting drum shown in FIG. 16A;

FIG. 18 is a front view of the cutting drum shown in FIG. 16A;

FIG. 19 is a front view of a cutting drum according to another embodiment;

FIG. 20 is a front view of a cutting drum according to another embodiment;

FIG. 21 is a front expanded view of a cutting drum according to another embodiment showing a debris guard;

FIG. 22 is a front assembled view of the cutting drum shown in FIG. 21; and

FIG. 23 is a perspective expanded view of the cutting drum shown in FIG. 21.

### DETAILED DESCRIPTION

A forestry mulching or mowing head comprises a frame that is mountable onto a movable working arm of a self-propelled vehicle, such as an excavator or loader boom, and a rotating cutting drum rotationally mounted to the frame that comprises cutting tools that are capable of shredding a material, such as wood or brush. The cutting tools are removably coupled to tool holders that are organized around a curved outer surface of the cutting drum in a pattern that limits the number of cutting tools that are in contact with the material at a given time. In some embodiments, the tool holders and the cutting tools are arranged in a helical or spiraled configuration. Moreover, to limit the depth of cut of the cutting tools and reduce interference of the material being projected radially outward of the cutting drum, the cutting drum comprises a bite limiter assembly. The bite limiter assembly can comprise one or more guide plates that preferably extend along the length of the drum at an angle to the rotational axis of the drum. In possible configurations, the bite limiter assembly comprises at least one helical guide plate or a series of guide plates. In possible configurations, at least some of the guide plates extend continuously along the outer surface of the drum, from the first end to the second end, such that the bite limiter assembly has a generally helical shape. In other configurations, the series of guide plates are assembled along the length of the drum in a helical or angled configuration. In some configurations, the guide plates can be coupled to the drum in a continuous manner, such that a leading end of a respective guide plate is abutting a trailing end of an adjacent guide plate. In other configurations, the tool holders, and thus cutting tools, can be dispersed between two adjacent guide plates, such that a leading end of a respective guide plate abuts the trailing side of a respective tool holder and a trailing end of an adjacent guide plate is abutting a leading side of the respective tool holder. By reducing the depth of the cut of the cutting tools into the material, the guide plates reduce or prevent the cutting drum from slowing down or stalling. In some embodiments, the guide plates following a similar helical configuration as the tool holders and cutting tools on the cutting drum. If an amount of material is removed too quickly by the cutting tools, the guide plates come into contact with the material and prevent the cutting tools from cutting into the material at a deeper depth until enough material is removed, thus limiting a depth of engagement of the cutting tools.

Furthermore, the helical or angled configuration of the tool holders and the cutting tools and/or the guide plates can be arranged in a way to orient the shredded material in a particular direction, such as towards the first or second side of an axial center of the cutting drum, towards the axial center of the cutting drum, or toward the first and second side of the cutting drum. In some embodiments, the helical configuration of the tool holders and cutting tools and/or the guide plates is arranged to direct a portion of the shredded material toward the axial center of the cutting drum, which requires less manipulations for the operator and allows for multiple shredding passes of the cutting drum as the shredded material is directed radially and axially along the drum. For example, when a large piece of material is being shredded, such as a large tree trunk, larger portions that are torn from the material can come into contact with multiple cutting tools axially along the length of the cutting drum simultaneously, thus size-reducing the material to provide a finer end product.

In some embodiments, the cutting drum includes a debris guard at both ends of the cutting drum to prevent debris from entering the hollow interior of the cutting drum, thus protecting the rotating portions of the cutting drum, such as the drive shaft and bearings. The debris guard can comprise concentric rings of alternate sizes that interlock with each other to create a labyrinth of end plates that prevent shredded material of a given size from entering the hollow interior of the cutting drum.

In some embodiments, a cavity can be formed on one side of the interior of the cutting drum to hold at least a portion of the rotating assembly internally within the cutting drum. The rotating assembly can include a mounting flange, bearings, a drive shaft, a motor, and other rotating hardware. When at least a portion of the rotating assembly is located in the cutting drum, the overall length of the frame can be reduced, allowing easier in-service operation, and increased efficiently in avoiding obstacles during use. In some embodiments, the motor has a direct connection with the drive shaft driving the cutting drum, thus limiting the number of moving parts for increased reliability.

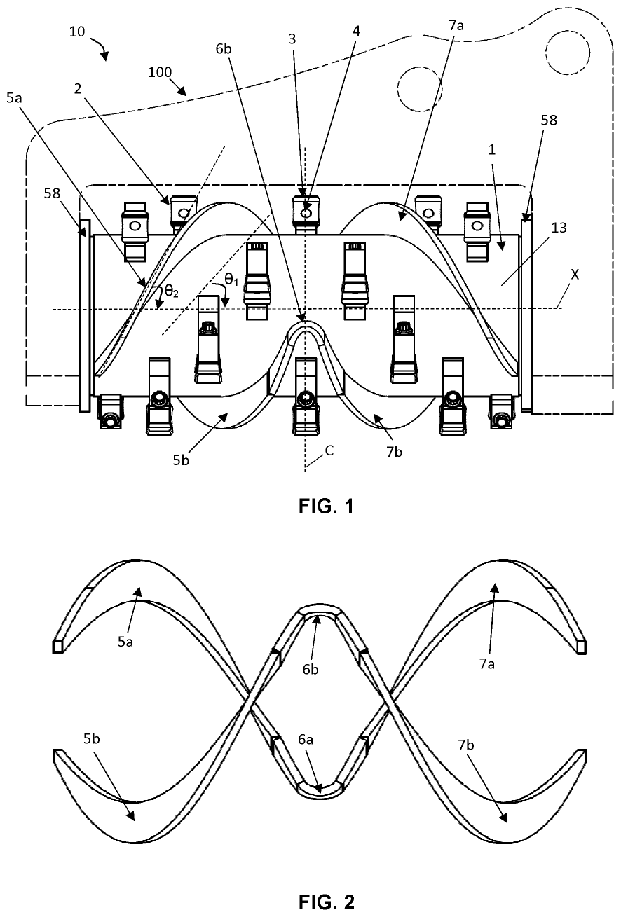

Referring now to FIG. 1, a front view of a mulcher head 10 is shown. The mulcher head 10 comprises a frame 100 shown in dashed lines. The frame 100 provides structural support for a rotating cutting drum 1, which is rotationally coupled to the frame 100. The cutting drum 1 is a tubular body comprising substantially planar ends and a curved outer surface 13 with a plurality of tool holders 2, each configured to receive a cutting tool 3. The cutting drum 1 further comprises a bite limiter assembly coupled to the curved outer surface 13. In this exemplary embodiment, the bite limiter assembly comprises guide plates 5a, 5b, 7a, and 7b. The tool holders 2 and/or the guide plates 5a, 5b, 7a, and 7b are operatively coupled to the outer surface 13 of the cutting drum 1 with a welded joint, bolts, screws, or other known means of attachment.

Each of the plurality of tool holders 2 are configured to receive a cutting tool 3 that engages with and shreds, grinds, or otherwise size-reduces the material, such as trees, shrubs, and other organic materials. Each of the plurality of cutting tools 3 are equipped with one or more sharp edges to cut and/or shred the material. In some embodiments, the cutting tools 3 are removably attached to the tool holders to facilitate easier replacement and/or maintenance. The cutting tools 3 can be removably secured to the respective tool holder 2 with a fastener 4. The cutting tools 3 can have one or more threaded or non-threaded apertures for receiving the fastener 4, such as a partially or fully threaded cylindrical body, for example a bolt. In some embodiments, the tool holders 2 can merely be threaded or non-threaded apertures in the cutting drum 1 that are configured to receive the fastener 4 and retain the cutting tools 3 on the cutting drum 1.

In the illustrated embodiment, the tool holders 2 are coupled to the curved outer surface 13 in a helical pattern that reverses chirality at an axial center C of the cutting drum 1. In this context, chirality or handedness refers to a lack of mirror symmetry in the helical pattern that cannot be remedied by a change in translation along the axis. A helical configuration can have a right-handed chirality or handedness (i.e., with a line of sight along an axis of the helix, the helix moves away from the observer when moved in a clockwise direction) or a left-handed chirality (i.e., with a line of sight along an axis of the helix, the helix moves towards the observer when moved in a clockwise direction). Due to the reverse chirality at the axial center C of the cutting drum 1, when the cutting drum 1 is rotating the cutting tools 3 coupled to the tool holders 2 at both axial ends of the cutting drum 1 direct a portion of the shredded material toward the axial center C of the cutting drum 1. This configuration is one of many possible configurations and is non-limitative. Adjacent tool holders 2 can be axially offset from each other by an angle θ₁ with a rotational axis X of the cutting drum 1, creating a helical configuration with a helical angle of θ₁. In some embodiments, the helical angle θ₁ can be between about 5° and about 85°, and preferably between about 50° and about 85°. In the exemplary embodiment of FIG. 1, the helical angle θ₁ is about 59°.

In some embodiments, opposing tool holders 2 that extend radially from opposing sides of the curved outer surface 13 can be located in the same axial plane on opposing sides of the curved outer surface 13 to provide balance while the cutting drum 1 is rotating. Alternatively, the opposing tool holders 2 can be offset from each other. In some embodiments, tool holders 2 on opposing ends of the cutting drum 1 at equal distances from the axial center C can be located in the same axial plane such that opposing ends of the cutting drum 1 are balanced. In some embodiments, the tool holders 2 are positioned such that the cutting drum 1 is self-balancing. When the helical configuration of the tool holders 2 reverses direction at the axial center C, adjacent tool holders 2 in a center section of the cutting drum 1 can be located side by side in the same axial plane on the same side of the curved outer surface 13. Other configurations of the tool holders 2 are also possible, such as the tool holders 2 being configured in a continuous helical pattern that extends between the opposite ends of the tubular body and continuously winds around the outer surface 13 of the cutting drum 1, such that the shredded material is directed towards on side of the cutting drum 1. In some embodiments, the tool holders 2 can be configured in a helical configuration that reverses chirality at the axial center to direct the shredded material to opposing sides of the cutting drum 1. In other embodiments, the tool holders 2 can be configured in a non-helical and spaced apart configuration. For example, some of the tool holders 2 can be located in the same axial plane on a single side of the curved outer surface 13, such as in rows that extend axially along the cutting drum 1.

Referring now to FIGS. 1 and 2, the bite limiter assembly comprises two first guide plates 5a, 5b that are operatively coupled to a first side of the outer surface 13 of the cutting drum 1 and two second guide plates 7a, 7b that are operatively coupled to a second side of the outer surface 13 of the cutting drum 1. In some embodiments, the helical configuration of the first guide plates 5a and 5b are congruent helices with an axis that corresponds to the axis X of the cutting drum 1 and thus form a first double helical configuration. Similarly, the helical configuration of the second guide plates 7a and 7b can be congruent helices with an axis that corresponds to the axis X of the cutting drum 1 and thus form a second double helical configuration. The helical configuration can also be referred to as a helicoidal configuration. In this exemplary embodiment, the first double helix configuration has a chirality that is opposite that of the second double helix. In some embodiments, the first guide plates 5a and 5b and the second guide plates 7a and 7b each form a non-congruent double helix configuration.

In the exemplary embodiment shown in FIGS. 1 and 2, the first guide plates 5a, 5b comprise a left-handed double helix and the second guide plates 7a, 7b comprise a right-handed double helix, which, when the cutting drum 1 is rotated, direct the shredded material to the center region of the cutting drum 1. In this embodiment, the bite limiter assembly further comprises connection guide plates 6a, 6b to connect the respective first guide plates 5a, 5b and second guide plates 7a, 7b to each other at or near the axial center C where the chirality is reversed. Accordingly, the first guide plate 5a and the second guide plate 7a are connected at the axial center C with the connection guide plate 6a. Similarly, the first guide plate 5b and the second guide plate 7b are connected at the axial center C with the connection guide plate 6b. In some embodiments, the connection guide plates 6a, 6b are substantially v-shaped or u-shaped and connect the first guide plates 5a, 5b and the second guide plates 7a, 7b, respectively, allowing the double helical configuration of the guide plates to reverse chirality at the axial center C.

In some embodiments, the helical configuration of the bite limiter assembly can be coupled to the outer surface 13 of the cutting drum at a helical angle θ₂ with the rotational axis X of the cutting drum 1, creating a helical configuration with a helical angle of θ₂. In some embodiments, the helical angle θ₂ is between about 45° and about 89°, and preferably between about 65° and about 85°. In the exemplary embodiment of FIG. 1, the helical angle θ₂ is about 65°. In some embodiments, the helical angle θ₁ of the tool holders 2 can be the same or substantially the same as the helical angle θ₂ of the bite limiter assembly, or the tool holders 2 and the bite limiter assembly can be coupled to the outer surface 13 of the cutting drum 1 with differing spatial arrangements and/or helical angles.

In some embodiments, the bite limiter assembly comprises a single, continuous guide plate that extends from the first end of the cutting drum 1 to the second end in a helical configuration. In other embodiments, the bite limiter assembly comprises two continuous guide plates that reverse chirality at or near the axial center C of the cutting drum 1. In this embodiment, the first guide plate 5a, the connection guide plate 6a, and the second guide plate 7a would comprise a single, continuous guide plate and the first guide plate 5b, the connection guide plate 6b, and the second guide plate 7b would comprise a second continuous guide plate. It is understood that the bite limiter assembly, including the first guide plates 5a, 5b, the connection guide plates 6a, 6b, and the second guide plates 7a, 7b can comprise one or multiple sections welded together at the ends thereof and can be configured to coupled to any cutting drum diameter and/or width.

In some embodiments, the bite limiter assembly, such as first guide plates 5a, 5b and the second guide plates 7a, 7b, can be coupled to a back side of the tool holders 2 on the non-cutting edge side of the cutting tool 3. Alternatively, the bite limiter assembly, such as first guide plates 5a, 5b and the second guide plates 7a, 7b, can be coupled to the cutting drum 1 adjacent to the non-cutting edge side of the cutting tool 3. When determining the spatial relationship between the tool holders 2 and the bite limiter assembly, the cutting edge side of the cutting tool 3 should be free of obstacles when the cutting drum 1 is rotated.

It is also contemplated that the plurality of tool holders 2 and/or the bite limiter assembly can be configured to direct the shredded material towards one end of the cutting drums when the tool holders 2 and the guide plate(s) form a helix with a single chirality, such as a left-handed helix or a right-handed helix. In other embodiments, the plurality of tool holders 2 and the bite limiter assembly can be configured to direct the shredded material to an axial center C of the cutting drum 1 or towards both ends of the cutting drum 1, in which case the tool holders 2 and/or the guide plates on the first side of the axial center C of the cutting drum 1 will be arranged in a helix with a different chirality than the helix formed by the tool holders 2 and/or guide plates on the second side of the cutting drum 1.

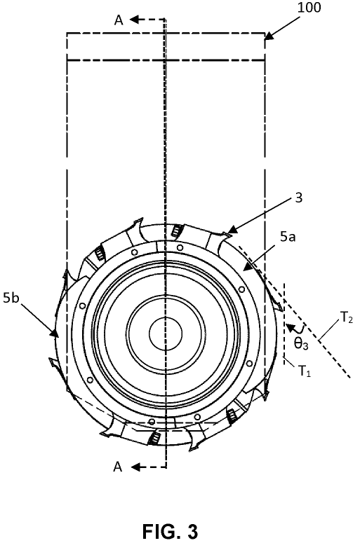

Referring now to FIG. 3, a side view of the mulcher head 10 is shown. As can be seen, the cutting edge of the cutting tools 3 extend radially out from the cutting drum 1 and extend past a guide radius extending from the axis X to an exterior edge of the first guide plates 5a, 5b and the second guide plates 7a, 7b. The guide radius of the guide plates is smaller than a cutting radius that extends from the axis X to the cutting edge of the cutting tools 3. When the uncut material comes into contact with the cutting drum 1, the cutting tools 3 shred and/or cut the portion of the material at a depth of engagement that generally corresponds to the portion of the cutting tools 3 that extends beyond the guide radius of the first guide plates 5a, 5b and the second guide plates 7a, 7b. In some embodiments, the angle θ₃ created by a cutting tangential path line T₁ from the cutting path made by the rotation of the cutting tools 3 (i.e., a tangent line extending from the cutting path having a radius equal to the cutting radius) and a guide tangential path line T₂ along the guide path made by the rotation of the first guide plates 5a, 5b and the second guide plates 7a, 7b (i.e., the guide path having a radius equal to the guide radius) can range from between about 5° and about 45°.

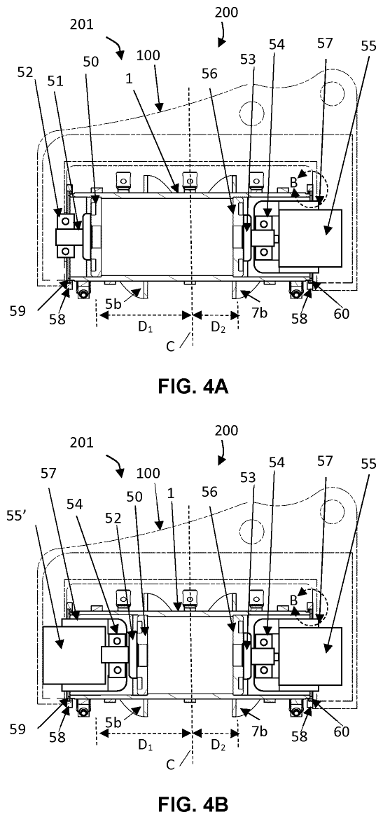

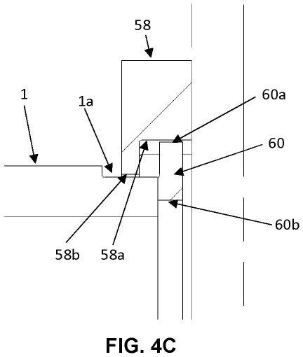

Referring now to FIG. 4A, the cutting drum 1 comprises a tubular body with a first mounting plate 50 and a second mounting plate 56 coupled at opposing ends of the cutting drum 1. The first mounting plate 50 and the second mounting plate 56 provide a coupling interface for a first rotational shaft 51 and a and a second rotational shaft 53, respectively. The first rotational shaft 51 is coupled to a first bearing 52 or other rotational friction reducing device to reduce friction between the first rotational shaft 51 and the frame 100. The second rotational shaft 53 is a drive shaft operatively connected to a motor 55 with a mounting flange 57 and a second bearing 54 or other rotational friction reducing device.

The first mounting plate 50 is coupled to the cutting drum 1 at a first axial distance D₁ between the first mounting plate 50 and the axial center C on the first side the cutting drum 1. Similarly, the second mounting plate 56 is coupled to the cutting drum 1 at a second axial distance D₂ between the second mounting plate 56 and the axial center C on the second side of the cutting drum 1. In some embodiments, the second axial distance D₂ is shorter than the first axial distance D₁. For example, the second axial distance D₂ can be about 20% to 70% shorter than the first axial distance D₁. This offset of axial distance between the axial center C and the second mounting plate 56 creates a cavity within the tubular body of the cutting drum 1 to allow the rotational assembly to be installed at least partially inside the cavity drum 1 and thus reduce the overall length of the frame 100. The rotational assembly comprises the motor 55, the mounting flange 57, the second bearing 54, and other rotational components. The direct connection between the motor 55 and the driven shaft 53 of the cutting drum 1 limits the number of parts required to drive rotation of the cutting drum 1. In other embodiments, the first mounting plate 50 and the second mounting plate 56 have an equal axial distance D₁, D₂ from the axial center C of the cutting drum. In this embodiment, the mounting flange 57 and the motor 55 can be located partially or fully outside the cutting drum 1 and, optionally, in an extended portion of the frame 100.

Referring to FIG. 4B, another possible configuration of a cutting drum 1 is shown. In this configuration, two motors 50, 50′ are provided on each side of the drum. In this embodiment, the two motors are mirrored, but the motors and/or the mounting flanges can be of different sizes, such that a bigger motor is provided one end, and a smaller motor is provided on the other end.

Referring now to FIG. 4C, an enlarged view of a portion of the second end of the cutting drum 1. The cutting drum 1 can comprise a debris guard that comprises concentric interlocking rings and grooves of alternate sizes to prevent shredded material of a given size from entering the hollow interior of the cutting drum 1.

The debris guard comprises a groove 1a at each end of the cutting drum 1 that is configured to receive a grooved plate 58 that is coupled to the frame 100 with known coupling means, such as fasteners or a welded joint. In some embodiments, the grooved plate 58 can comprise two plates, such as semicircle shaped planar plates. In other embodiments, the grooved plate 58 can comprise a single circular plate that is configured to be coupled by known fastening means to the frame 100. The grooved plates 58 each comprise a groove 58a and a protrusion 58b. The protrusion 58b is configured to fit in the groove 1a of the cutting drum 1, while still allowing the cutting drum 1 to freely rotate. Accordingly, an interior diameter of the protrusion 58b is slightly larger than an exterior diameter of the groove 1a of the cutting drum 1.

The debris guard can further comprise a first ring 59 coupled to the first mounting plate 50 and a second ring 60 coupled to the second mounting plate 56. The first ring 59 and the second ring 60 are concentric to the rotational axis of the cutting drum 1 and are configured to rotate with the cutting drum 1. The first ring 59 and the second ring 60 have an exterior diameter (i.e., the diameter taken from the outer surface 60a) that is slightly larger than the exterior diameter of the tubular drum 1. An interior diameter of the first ring 59 and the second ring 60 (i.e., the diameter taken from the inner surface 60b) that is slightly smaller than the exterior diameter of the groove 1a in the cutting drum 1. The inner diameter of the groove 58a is slightly larger than the exterior diameter of the first ring 59 and the second ring 60, thus preventing shredded material from passing the grooved plate 58 and entering the interior of the cutting drum.

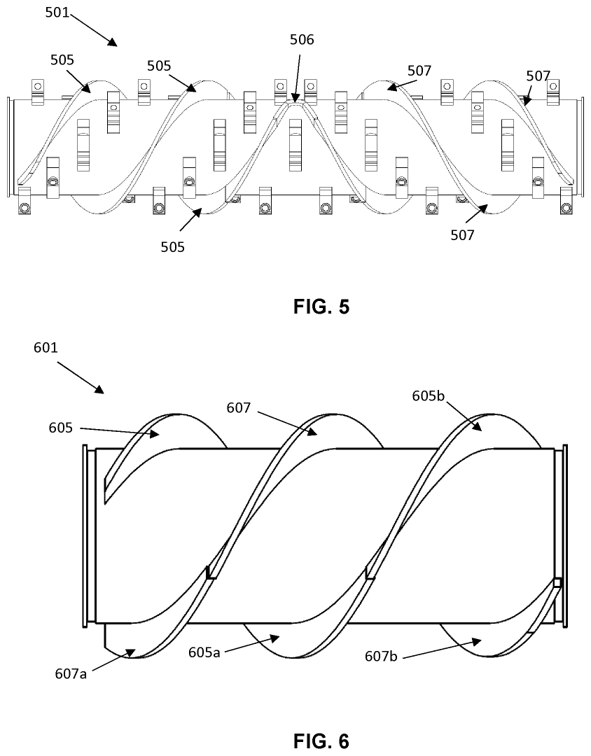

Referring now to FIG. 5, an alternate embodiment of a cutting drum 501 is shown. The cutting drum 501 comprises a tubular body with a bite limiter assembly coupled to a curved outer surface of the cutting drum 501. The bite limiter assembly comprises first guide plates 505 coupled to a first side thereof that are arranged around the tubular body in a left-hand double helix configuration and second guide plates 507 on a second side of the cutting drum 501 that are arranged around the cutting drum 501 in a right-hand double helix configuration, such that the shredded material is directed to an axial center of the cutting drum 501. The first guide plates 505 and the second guide plates 507 are connected with connection plates 506 that are u-shaped or v-shaped to connect the first guide plates 505 and the second guide plates 507 and reverse the chirality of the double helix. The length of the cutting drum 501 is such that each of the first guide plates 505 and the second guide plates 507 complete at least one full rotation around the cutting drum 501 on their respective sides of the axial center of the cutting drum 501. It is contemplated that the first and second guide plates can be configured to extend along any length of cutting drum 501 and comprise any configuration of pitch and any number of rotations. It is understood that the bite limiter assembly can comprise one or multiple sections welded together at the ends thereof and can be configured to coupled to any cutting drum diameter and/or width. Accordingly, in some embodiments, the bite limiter assembly can comprise two continuous helical guide plates, each comprising one first guide plate 505, connection guide plate 506, and a second guide plate 507, that extend from the first side to the second side of the cutting drum 501.

Referring now to FIG. 6, another embodiment of a cutting drum 601 comprising a bite limiter assembly is shown. The bite limiter assembly comprises a first guide plate 605 and a second guide plate 607 that are arranged in a continuous left-hand double helix configuration that extends from a first end of the cutting drum 601 to a second end. The first guide plate 605 can be comprised of multiple guide plates 605a, 605b that are coupled to the cutting drum 601 with their respective ends abutting to create a single continuous helix around the cutting drum 601. Similarly, the second guide plate 607 can comprise multiple guide plates 607a, 607b with their respective ends abutting to create a single continuous helix congruent or near congruent to the helix of the first guide plate 605. Alternatively, the first guide plate 605 and the second guide plate 607 can each comprise a single, continuous helical guide plate that extends from the first side to the second side of the cutting drum 601.

In this exemplary embodiment, the bite limiter assembly comprising the first guide plate 605 and the second guide plate 607 forms a single chirality double helix that directs the shredded material to one side of the cutting drum 601. It is understood that the guide plates can be assembled by any number of parts and be coupled to the cutting drum 601 with their ends abutting or with their respective ends separated by a gap. As the material being shredded comes in direct contact with the outer surface of the guide plates, consideration should be given to the shape and configuration of the outer surface of the guide plates to avoid the uncut material from catching on the guide plate and stalling the cutting drum 601. In some embodiments, the outer surfaces of the guide plates are smooth and/or without gaps to deflect the uncut material.

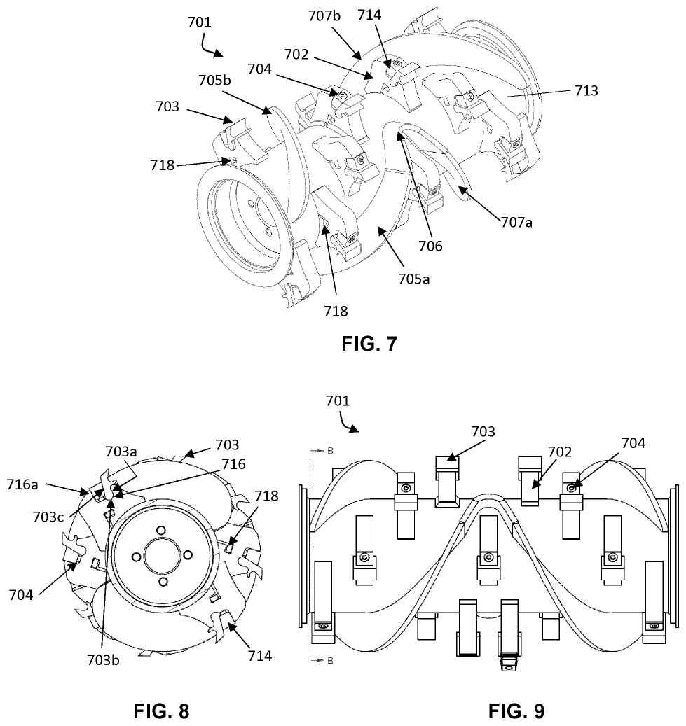

Referring now to FIGS. 7 to 9, a cutting drum 701 according to another embodiment is shown. The cutting drum 701 comprises a plurality of tool holders 702 and a bite limiter assembly coupled to a curved outer surface 713 of the cutting drum 701. The bite limiter assembly comprises first guide plates 705a, 705b and second guide plates 707a, 707b coupled to the curved outer surface 713 of the cutting drum 701. The plurality of tool holders 702 and the guide plates 705a, 705b, 707a, 707b are coupled to the curved outer surface 713 of the cutting drum 701 in a double helix configuration that reverses chirality near an axial center of the cutting drum 701. It is, however, contemplated that the plurality of tool holders 702 and the guide plates 705a, 705b, 707a, 707b can be coupled to the cutting drum 701 in a helical pattern that is continuous along the length of the cutting drum 701.

The plurality of tool holders 702 are each configured to receive a cutting tool 703. The cutting tools 703 comprise a cutting edge side 703a with one or more sharp edges to cut and/or shred material, a bottom side 703b, and a non-cutting edge side 703c opposite the cutting edge side 703a. The tool holders 702 each comprise a recess 716 that is configured to receive the cutting tool 703 and a wedge 714. In this embodiment, the cutting tools 703 can be secured in the tool holder 702 with the wedge 714 to provide an interference fit. The recess 716 is configured to receive the cutting tool 703 such that the cutting edge side 703a and the bottom side 703b of the cutting tool 703 abut against a front side and a bottom side of the recess 716, respectively. The recess 716 is further configured to receive the wedge 714 that secures the cutting tool 703 in place by abutting against a back side 716a of the recess 716 and the non-cutting edge side 703c of the cutting tool 703 to provide an interference fit.

In this embodiment, the cutting tool 703 does not include apertures for receiving fasteners as the wedge 714 is fastened to the tool holder 702. The wedge 714 comprises one or more apertures configure to receive therethrough one or more fasteners 704, such as partially or fully threaded cylindrical bodies, to secure the wedge 714 to the tool holder 702. In some embodiments, the apertures can be counterbored or countersunk. The tool holders 702 further comprise at least one non-cylindrical opening 718 on one side of the tool holders 702 that is configured to receive a non-cylindrical threaded body (not shown), such as a square or hexagonal nut. One or more non-cylindrical threaded bodies are configured to fit inside the non-cylindrical opening 718 and receive the fastener 704 that extends through the wedge 714, thus block the rotation or movement of the cutting tool 703 when the cutting drum 701 is rotating. It is understood that when the wedge 714 comprises more than one aperture for receiving more than one fastener 714, the corresponding tool holder 702 would have an equal number of non-cylindrical openings 718 to receive an equivalent number of the non-cylindrical threaded bodies. In some embodiments, more than one non-cylindrical threaded bodies can be received in a single non-cylindrical opening 718. For example, when the wedge 714 is configured to receive more than one fastener 704 to secure the wedge 714 to the tool holder 702, the non-cylindrical opening 718 can be configured to receive more than one non-cylindrical threaded bodies, each non-cylindrical threaded body being configured to receive a fastener 704. In other embodiments, the apertures in the tool holders 702 that are configured to receive the fasteners 704 can comprise threaded holes that are configured to receive a threaded fastener 704 therethrough, thus not requiring a non-cylindrical threaded body. In some embodiments, the apertures in the tool holders 702 and the wedges 714 that are configured to receive a fastener 704 extend radially or substantially radially from the cutting drum 701.

The wedge 714 can comprise any shape with two or more inclined planes. In the exemplary embodiment shown in FIGS. 7 to 9, the wedge 714 comprises a trapezoidal shape, however, any shape of wedge 714 that facilitates an interference fit between the cutting tool 703 and the tool holder 702 can be used. In some embodiments, a washer or lock washer can be used to secure the fastener 704 against the wedge 714.

The first guide plates 705a, 705b and the second guide plates 707a, 707b each follow a double helix configuration with opposing chirality. The first guide plates 705a and 705b extend along a front side of the cutting drum 701 in a double left-handed helix configuration from a first side to an axial center of the cutting drum 701 and the second guide plates 707a, 707b extend along the cutting drum 701 in a double right-handed helix configuration from a second side to the axial center of the cutting drum 701. The first guide plate 705a and the second guide plate 707a are coupled to each other with a first connection plate 706a and the first guide plate 705b and the second guide plate 707b are coupled to each other with a second connection plate (not shown). Accordingly, the shredded material is directed towards the center of the cutting drum 701. In this exemplary embodiment, the bite limiter assembly comprises two guide plates that reverse chirality at or near an axial center of the cutting drum 701. The first guide plate of the bite limiter assembly can comprise first guide plate 705a, connection guide plate 706, and second guide plate 707a, while the second guide plate can comprise first guide plate 705b, connection plate 706, and second guide plate 707b. Alternatively, the bite limiter assembly can comprise any number of guide plates assembled in a continuous double helical configuration around the cutting drum 701 or in a continuous dual chirality double helical configuration that reverses chirality at or near an axial center of the cutting drum 701.

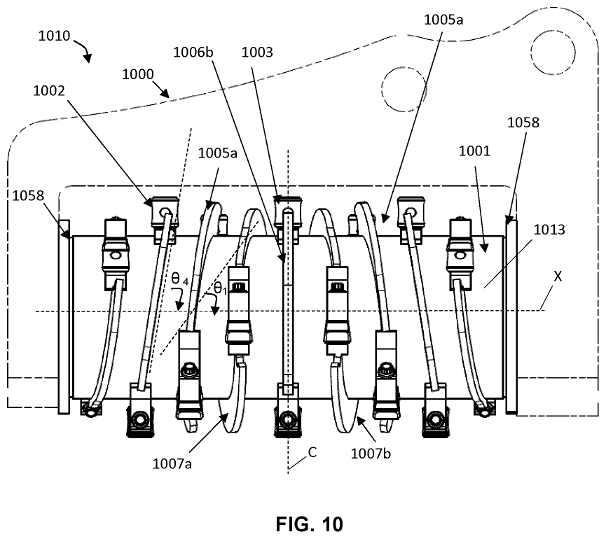

Referring now to FIG. 10, a front view of a mulcher head 1010 according to another embodiment is shown. The mulcher head 1010 comprises a frame 1000 shown in dashed lines. The frame 1000 provides structural support for a rotating cutting drum 1001, which is rotationally coupled to the frame 1000. The cutting drum 1001 is a tubular body with a curved outer surface 1013 that has a plurality of tool holders 1002 coupled to an outside thereof. Each tool holder 1002 is configured to receive and retain a cutting tool 1003. The cutting drum 1001 further comprises a bite limiter assembly coupled to the curved outer surface 1013. In this exemplary embodiment, the bite limiter assembly comprises a series of guide plates that are aligned with the tool holders 1002, such that the ends of each of the series of guide plates are separated from each other by the tool holders 1002. Accordingly, the guide plates do not extend continuously around the curved outer surface 1013 of the drum 1001. In some embodiments, the outer surface of the tool holders 1002 can form part of the bite limiter assembly. The tool holders 1002 and/or the series of guide plates are operatively coupled to the outer surface 1013 of the cutting drum 1001 with a welded joint, bolts, screws, or other known means of attachment.

Each of the plurality of tool holders 1002 are configured to receive and retain a cutting tool 1003 that engages with the material being shredded, ground, or otherwise size-reduced. In the illustrated embodiment, the tool holders 1002 are coupled to the curved outer surface 1013 in a substantially helical pattern that reverses chirality at an axial center C of the cutting drum 1001. In the exemplary embodiment, the guide plates are straight, such that the bite limiter assembly forms an angled configuration or substantially helical configuration on the cutting drum 1001. Due to the reverse chirality at the axial center C of the cutting drum 1001, when the cutting drum 1001 is rotated, at least a portion of the shredded material is directed toward the axial center C of the cutting drum 1001. This configuration is one of many possible configurations and is non-limitative. Adjacent tool holders 1002 can be axially offset from each other by an angle θ₁ with a rotational axis X of the cutting drum 1001, creating a helical configuration with a helical angle of θ₁. In some embodiments, the helical angle θ₁ can be between about 5° and about 85°, and preferably between about 45° and about 85°. In the exemplary embodiment, the helical angle θ₁ of the tool holders 1002 is 59°. The tool holders 1002 are configured in a helical configuration that is aligned with the helical configuration of the bite limiter assembly, such that the tool holders 1002 are coupled to the curved outer surface 1013 of the drum 1001 between two non-contiguous guide plates.

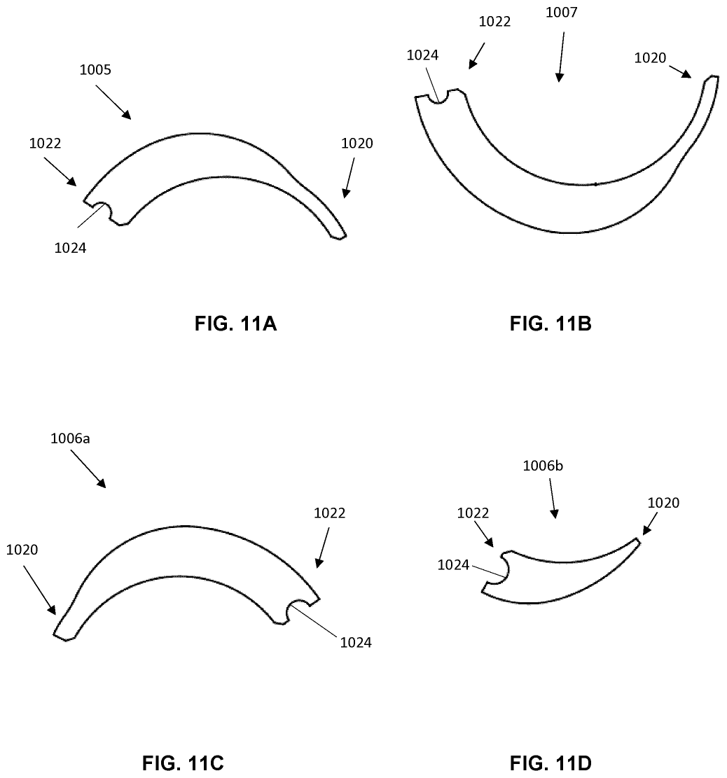

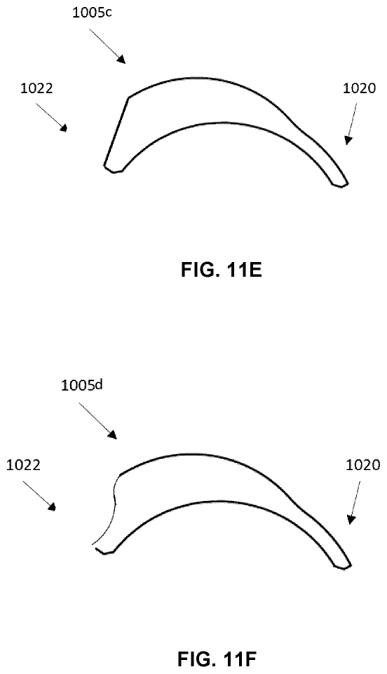

Referring now to FIGS. 10 to 11F, the bite limiter assembly comprises a first side having first minor guide plates 1005a (as shown in FIG. 11A) and first major guide plates 1007a (as shown in FIG. 11B) that are operatively coupled to a first side of the outer surface 1013 (i.e., on one side of the axial center C) of the cutting drum 1001 and a second side having second minor guide plates 1005b and second major guide plates 1007b that are operatively coupled to a second side of the outer surface 1013 of the cutting drum 1001. It is noted that in the exemplary embodiment, the second minor guide plates 1005b and the second major guide plates 1007b are substantially the same as first minor guide plates 1005a and the first major guide plates 1007a, respectively, except in that the guide plates on the second side are coupled to the cutting drum 1001 with a reverse handedness or chirality than the guide plates on the first side and/or are coupled to the cutting drum 1001 at an opposing angle than on the first side. In some embodiments, the minor guide plates 1005, the major guide plates 1007, the minor center guide plates 1006a, and/or the major center guide plates 1006b are comprise of a plate, such as a metal plate, that is substantially straight. In such embodiments, the guide plates are coupled to the cutting drum 1001 at an angle to create a substantially helical configuration or an angled configuration.

In some embodiments, the helical or angled configuration of the first minor guide plates 1005a and the first major guide plates 1007a is a single helix with an axis that corresponds to the axis X of the cutting drum 1001 and thus form a first helical configuration. Similarly, the helical or angled configuration of the second minor guide plates 1005b and second major guide plates 1007b can be a single helix with an axis that corresponds to the axis X of the cutting drum 1001 and thus form a second helical configuration. In this exemplary embodiment, the first helix configuration has a chirality that is opposite that of the second helix configuration, such that when the cutting drum 1001 is rotated, the bite limiter assembly directs the shredded material to the center region of the cutting drum 1001. In this embodiment, the bite limiter assembly further comprises a major center guide plate 1006a (as shown in FIG. 11C) and a minor center guide plate 1006b (as shown in FIG. 11D) that are coupled to the cutting drum 1001 in an orientation that is substantially perpendicular to the axis of rotation X (i.e., parallel to the center axis C). In the exemplary embodiment, when assembled to the cutting drum 1001, the major and minor center guide plates 1006a, 1006b separate the first minor and major guide plates 1005a, 1007a on the first side and the second minor and major guide plates 1005b, 1007b on the second side. In this exemplary embodiments, the guide plates on the first side and the guide plates on the second side are not connected or contiguous and are separated by the tool holders 1002.

In the exemplary embodiment, the helical configuration of the bite limiter assembly is coupled to the outer surface 1013 of the cutting drum 1001 at a helical angle θ₄ with the rotational axis X of the cutting drum 1001, creating a helical configuration with a helical angle of θ₄. In some embodiments, the helical angle θ₄ is between about 65° and about 89°, or between about 70° and about 85°. In the exemplary embodiment of FIG. 10, the helical angle θ₄ is about 82.4°. In some embodiments, the tool holders 1002 are placed between two adjacent guide plates. In some embodiments, the helical angle θ₁ of the tool holders 1002 is substantially the same as the helical angle θ₄ of the bite limiter assembly.

The bite limiter assembly, including the first minor and major guide plates 1005a, 1007a, the major and minor center guide plates 1006a, 1006b, and the second major and minor guide plates 1005b, 1007b, can comprise one or multiple sections welded together at the ends thereof and can be configured to coupled to any cutting drum diameter and/or width.

With specific reference to FIGS. 11A to 11D, in the exemplary embodiment, the helical guide plates on the first and second side are formed from a minor guide plate 1005 and a major guide plate 1007, which are spaced apart on the cutting drum 1001 by the tool holders 1003. A center guide plate is formed from a major center guide plate 1006a and a minor center guide plate 1006b, which are spaced apart by a tool holder 1003. When the cutting drum 1001 is rotated, each of guide plates 1005, 1006a, 1006b, and 1007 has a leading end 1020 and a trailing end 1022, as defined by the direction of rotation of the cutting drum 1001. In the exemplary embodiment, the leading end 1020 of each guide plate 1005, 1006a, 1006b, and 1007 is tapered, such that a guide radius R_{G} (i.e., a radial distance between the axis X to an exterior or peripheral edge of the leading end 1020) of the leading end 1020 is less than a guide radius R_{G} of the trailing end 1022.

When the guide plates 1005, 1006a, 1006b, 1007 and the tool holders 1002 are coupled to the cutting drum 1001, the cutting tools 1003 in the tool holders 1002 have a cutting edge side 1003a (or leading edge) with one or more sharp edges to cut and/or shred material and a non-cutting edge side 1003b (or trailing edge) opposite the cutting edge side. In some embodiments, the cutting edge side of the cutting tool 1003 includes a gullet to facilitate debris removal. Accordingly, the trailing end 1022 of some or each of guide plates 1005, 1006a, 1006b, and 1007 can includes a debris recess 1024 configured to facilitate additional debris removal with the cutting tools' gullets. The debris recess 1024 can comprise any shape that allows debris that has been cut off the organic material to freely move away from the cutting edge side 1003a. In some embodiments, the debris recess 1024 can comprises a curved shape that corresponds with the shape of the gullet on the cutting tool 1002 to create a spherical or dome shaped recess when the cutting tool 1002 is coupled to the cutting drum 1001.

In some embodiments, such as shown in FIGS. 11E and 11F, the trailing end 1022 of a guide plate 1005c can include a straight surface. In some embodiments, the straight surface can be angled to provide a debris removal area, such as shown in FIG. 11E. Alternatively, the trailing end 1022 of a guide plate 1005d can include a curved surface, such as shown in FIG. 11F. The curved surface can be configured to provide a debris removal area.

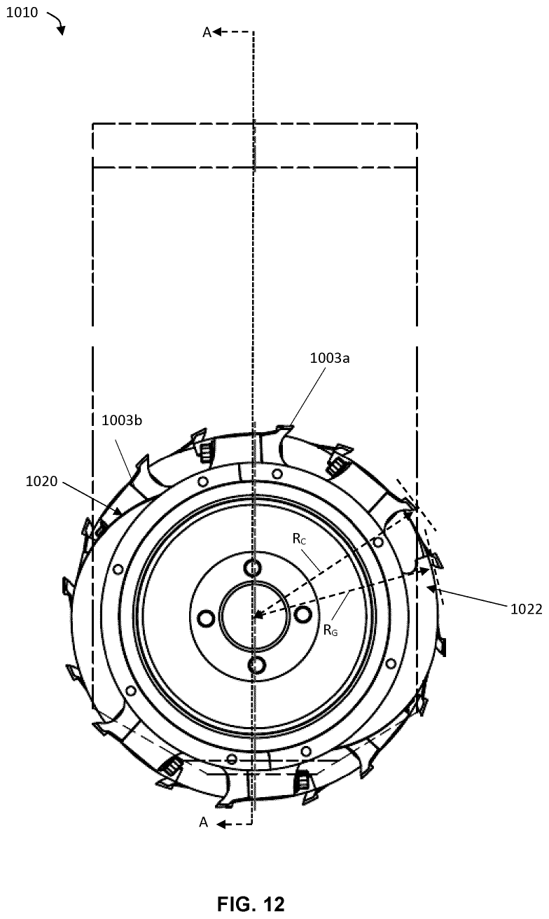

Referring to FIGS. 10 and 12, in the exemplary embodiment, the leading end 1020 of each of guide plates 1005a, 1007a, 1006a, 1006b, 1005b, and 1007b abuts against the non-cutting edge side 1003b (or trailing edge) of the tool holder 1002 with a cutting tool 1003. The trailing end 1022 of each of guide plates 1005a, 1007a, 1006a, 1006b, 1005b, and 1007b abuts against the cutting edge side 1003a (or leading edge) of an adjacent tool holder 1002 with a cutting tool 1003. In some embodiments, the debris recess 1024 is aligned with a gullet on the cutting tool 1003 to allow the debris to be cleared from the cutting edge side 1003a. A cutting radius R_{C} (i.e., the distance between the axis X of the cutting drum 1001 to the cutting edge 1003a of the cutting tool 1003) of the cutting tools 1003 is greater than the guide radius R_{G} of the trailing end 1022 of the guide plates 1005a, 1007a, 1006a, 1006b, 1005b, and 1007b. Accordingly, the bite limiter assembly restricts the engagement of the cutting tool 1003 with the material being shredded, as the cutting tool 1003 engages with a depth of material that equals the distance between the cutting radius R_{C} and the guide radius R_{G} at the trailing end 1022 of the respective guide plate.

Referring now to FIG. 12, a side view of the mulcher head 1010 is shown. As can be seen, the cutting edge 1003a of each of the cutting tools 1003 extends radially out from the cutting drum 1001 past the guide radius R_{G} of the guide plates. The guide radius R_{G} of the guide plates is smaller than the cutting radius R_{C} of the cutting tools 1003, such that when the uncut material comes into contact with the cutting drum 1001, the cutting tools 1003 shred and/or cut the portion of the material at a depth of engagement that generally corresponds to the portion of the cutting tools 1003 that extends beyond the guide radius R_{G} of the trailing end 1022 of the guide plates.

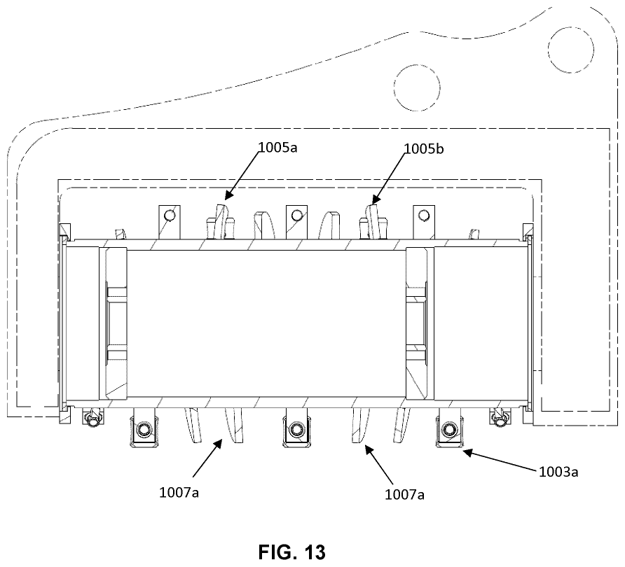

Referring now to FIG. 13, a cross sectional view of the cutting drum 1001 is shown. As can be seen, the cutting drum 1001 includes first minor guide plates 1005a and first major guide plates 1007a that are operatively coupled to a first side of the cutting drum 1001 and second minor guide plates 1005b and second major guide plates 1007b that are operative coupled to a second side of the cutting drum 1001.

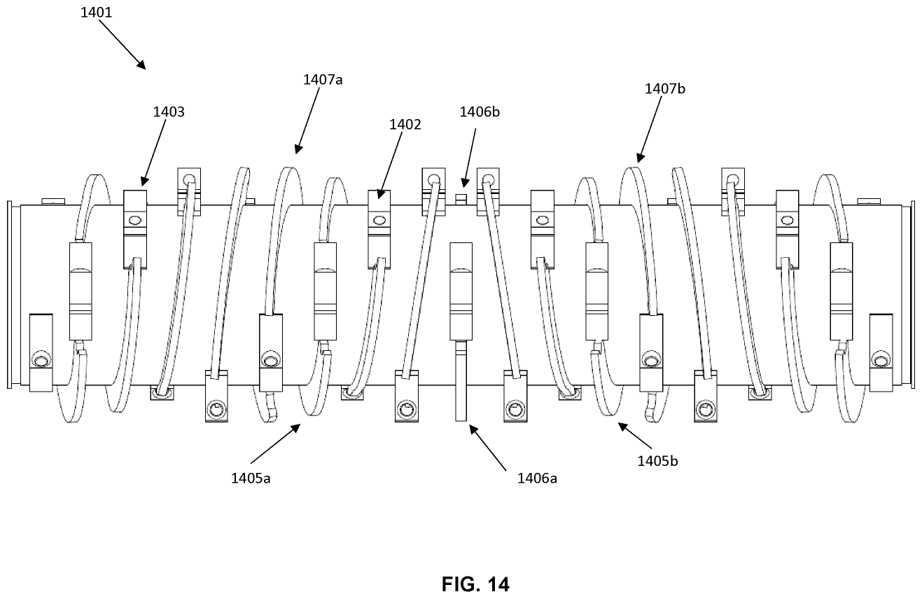

Referring now to FIG. 14, an alternate embodiment of a cutting drum 1401 is shown. The cutting drum 1401 comprises a tubular body with a bite limiter assembly coupled to a curved outer surface of the cutting drum 1401. The bite limiter assembly comprises first minor guide plates 1405a and first major guide plates 1407b coupled to a first side thereof that are arranged around the tubular body in a left-hand single helical configuration and second minor guide plates 1405b and second major guide plates 1407b on a second side of the cutting drum 1401 that are arranged around the cutting drum 1401 in a right-hand single helical configuration, such that the shredded material is directed to an axial center of the cutting drum 1401. As can be seen, the first and second minor guide plates 1405a, 1405b and the first and second major guide plates 1407a, 1407b have their respective ends abutting with the cutting tools 1403 to create a single continuous helix around the cutting drum 1401 with the cutting tools 1403.

The first minor and major guide plates 1405a, 1407a and the second minor and major guide plates 1405b, 1407b are not connected at an axial center of the cutting drum 1401. In this embodiment, the first and second helical configurations of the guide plates terminate near an axial center of the cutting drum 1401 and are separated by a center guide plate comprising a major center guide plate 1406a and a minor center guide plate 1406b. In the exemplary embodiment, the length of the cutting drum 1401 is such that the bite limiter on the first side and the bite limiter on the second side complete at least more than five full rotations around the cutting drum 1401 on their respective sides of the axial center of the cutting drum 1401.

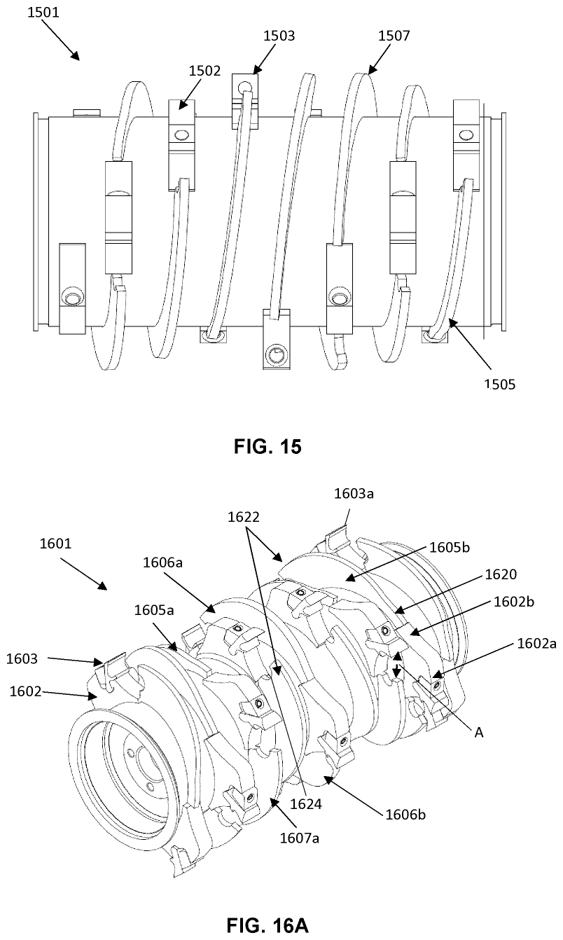

Referring now to FIG. 15, another embodiment of a cutting drum 1501 comprising a bite limiter assembly is shown. The bite limiter assembly comprises minor guide plates 1505 and major guide plates 1507 that are arranged in a continuous left-hand single helical configuration that extends from a first end of the cutting drum 1501 to a second end thereof. As can be seen, the minor guide plates 1505 and the major guide plates 1507 have their respective ends abutting with the tool holders 1502 to create a single continuous helix around the cutting drum 1501 with the tool holders 1502 containing a cutting tool 1503.

In this exemplary embodiment, the bite limiter assembly comprising the minor guide plates 1505 and the major guide plates 1507 forms a single chirality helix that directs the shredded material to one side of the cutting drum 1501. It is understood that the guide plates can be assembled by any number of parts and be coupled to the cutting drum 1501 with their ends abutting, with their respective ends separated by a gap, with their ends abutting the tools holders 1502 with cutting tools 1503, and/or with their ends abutting the tool holders 1502 with cutting tools 1503 and separated by a gap. As the material being shredded comes in direct contact with the outer surface of the guide plates, consideration should be given to the shape and configuration of the outer surface of the guide plates to avoid the uncut material from catching on the guide plate and stalling the cutting drum 1501. In some embodiments, the outer surfaces of the guide plates are smooth and/or without gaps to deflect the uncut material. In the exemplary embodiment, the leading end of the minor and major guide plates 1505, 1507 is tapered and abuts with the trailing end of the respective tool holder 1502 and the trailing end of the minor and major guide plates 1505, 1507 abuts with the leading end of the respective tool holder 1502.

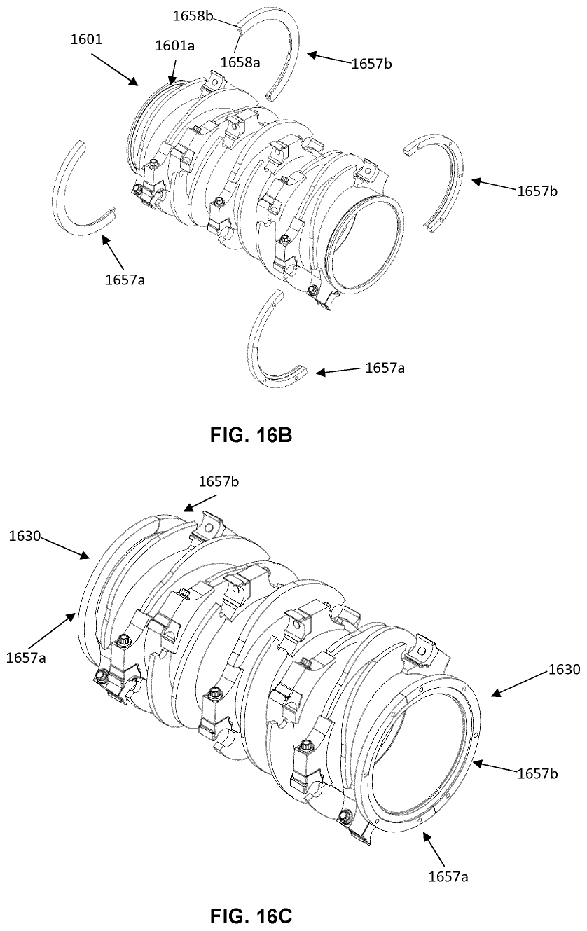

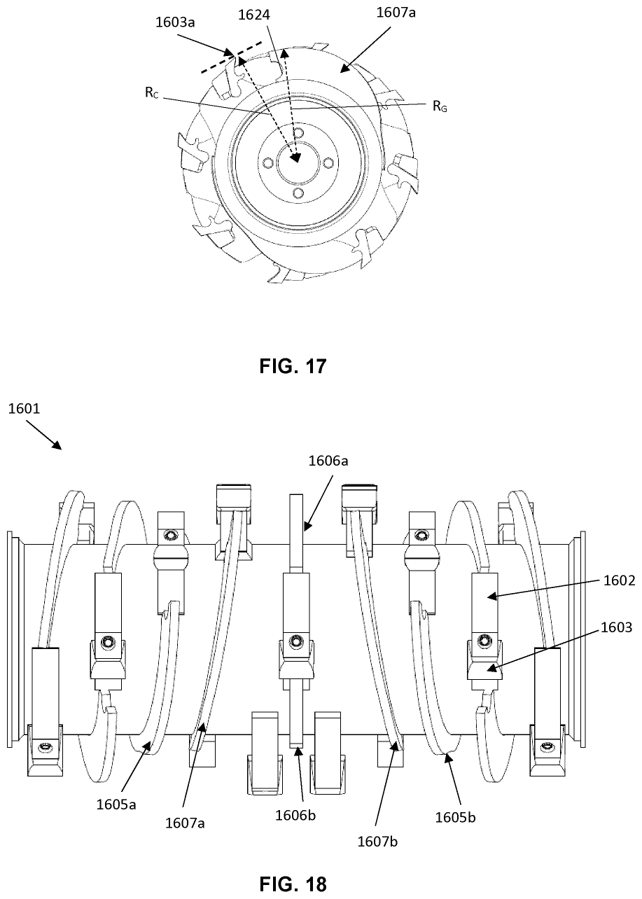

Referring now to FIGS. 16A to 18, a cutting drum 1601 according to another embodiment is shown. The cutting drum 1601 comprises a plurality of tool holders 1602 configured to hold a cutting tool 1603 and a bite limiter assembly coupled to a curved outer surface of the cutting drum 1601. The bite limiter assembly comprises first minor guide plates 1605a and first major guide plates 1607a on a first side of the cutting drum 1601 that form a first single helix configuration and second minor guide plates 1605b and second major guide plates 1607b coupled on a second side of the cutting drum 1601 that form a second single helix configuration having an opposing chirality to the first single helix configuration. Accordingly, the plurality of tool holders 1602 and the guide plates 1605a, 1605b, 1607a, 1607b are coupled to the curved outer surface of the cutting drum 1601 in a single helix configuration that reverses chirality near an axial center of the cutting drum 1601. In the exemplary embodiment, the bite limiter assembly further includes a major center plate 1606a and a minor center plate 1606b that are coupled to the cutting drum 1601 in an orientation that is substantially perpendicular to the axis of rotation of the cutting drum 1601.

The first and second minor guide plates 1605a, 1605b are aligned helically with a respective one of the first and second major guide plates 1607a, 1607b and are separated by one of the plurality of tool holders 1602 with a cutting tool 1603, such that the combination of the guide plates and the tool holders 1602 with the cutting tools 1603 form the single helix configuration that reverses chirality near the axial center of the cutting drum 1601.

As best shown in FIG. 16, the plurality of tool holders 1602 each include a leading side 1602a and a trailing side 1602b and are configured to receive a cutting tool 1603. The cutting tools 1603 can be coupled to the respective tool holder 1602 via a wedge, interference fit, fasteners, or other known means of attachment. In the exemplary embodiment, the cutting tools 1603 are coupled to the cutting drum 1601 such that a trailing (or non-cutting) side of the cutting tool 1603 abuts the leading side 1602a of the respective tool holder 1602 and is held in place via a wedge. The guide plates are aligned with the plurality of tool holders 1602, which in turn hold the cutting tools 1603, such that a leading end 1602a of a respective tool holder 1602 abuts a trailing end of the respective cutting tool 1603 and a trailing end 1602b of the respective tool holder 1602 abuts the leading end 1620 of a respective guide plate. In the exemplary embodiment, the respective guide plates are positioned at or near a center of the leading end 1602a or the trailing end 1602b of the respective tool holder 1602.

As can be seen in FIG. 16, the leading end 1620 of the second minor guide plate 1605b is tapered such that a guide radius of the leading end 1620 of the second minor guide plate 1605b is substantially similar to a radius of the trailing end 1602b of the tool holder 1602 (i.e., a distance between an axis of the cutting drum 1601 to a peripheral surface of the tool holder 1602). When the leading end 1620 of a respective guide plate directly abuts the trailing end 1602b of a tool holder, the connection point can comprise a smooth surface such that the outer surface of the tool holder 1602 forms part of the bite limiter assembly. Accordingly, each of the guide plates can have a leading end 1620 guide radius that is configured to be the same as the radius of the trailing end 1602b of the tool holders 1602. In some embodiments, the leading end 1620 of a respective guide plate can be separated from the trailing end 1602b of a tool holder 1602 by a gap and/or the leading end 1620 guide radius can differ from the radius of the trailing end 1602b of the tool holders 1602. It is contemplated that the guide plates can also be coupled to the cutting drum 1601 to directly abut each other with the tool holders 1602 being arranged around the cutting drum 1602 in an offset pattern adjacent to the bite limiter assembly. In such an embodiment, the guide plates can have a trailing end 1622 that does not include a debris recess 1624.

Each of the guide plates (i.e., first minor and major guide plates 1605a, 1607a, second minor and major guide plates 1605b, 1607b, and major and minor center guide plates 1606a, 1606b) include a debris recess 1624 at a trailing end 1622 thereof that is configured to create a debris release area A with a gullet of the respective cutting tool 1603 in the cutting tool holder 1602. Accordingly, when the tool holders 1602 are coupled to the cutting drum 1601 inline with the guide plates, the bite limiter assembly includes a gap between the cutting edge 1603a of each cutting tool 1603 and the trailing end 1622 of the respective guide plate. The debris release area A is configured to allow the debris being removed from the material being shredded to be removed from the cutting drum 1601 without clogging or blocking the ability of the cutting edge 1603a from removing further debris.

With specific reference to FIGS. 16B and 16C, the cutting drum 1601 can further include a debris guard 1630 on the terminal ends of the cutting drum 1601 that comprises concentric interlocking rings and grooves of alternate sizes to prevent shredded material of a given size from entering the hollow interior of the cutting drum 1601.

The debris guard 1630 can include a groove 1601a at each end of the cutting drum 1601 that is configured to receive a grooved plate that is coupled to the frame of the mulcher head with known coupling means, such as fasteners or a welded joint. In the exemplary embodiment, the grooved plate comprises a first grooved plate 1658a and a second grooved plate 1658b. The first and second grooved plates 1657a, 1657b each comprise a groove 1658a and a protrusion 1658b. The protrusion 1658b is configured to fit in the groove 1601a of the cutting drum 1601, while still allowing the cutting drum 1601 to freely rotate. Accordingly, an interior diameter of the protrusion 1658b is slightly larger than an exterior diameter of the groove 1601a of the cutting drum 1601.

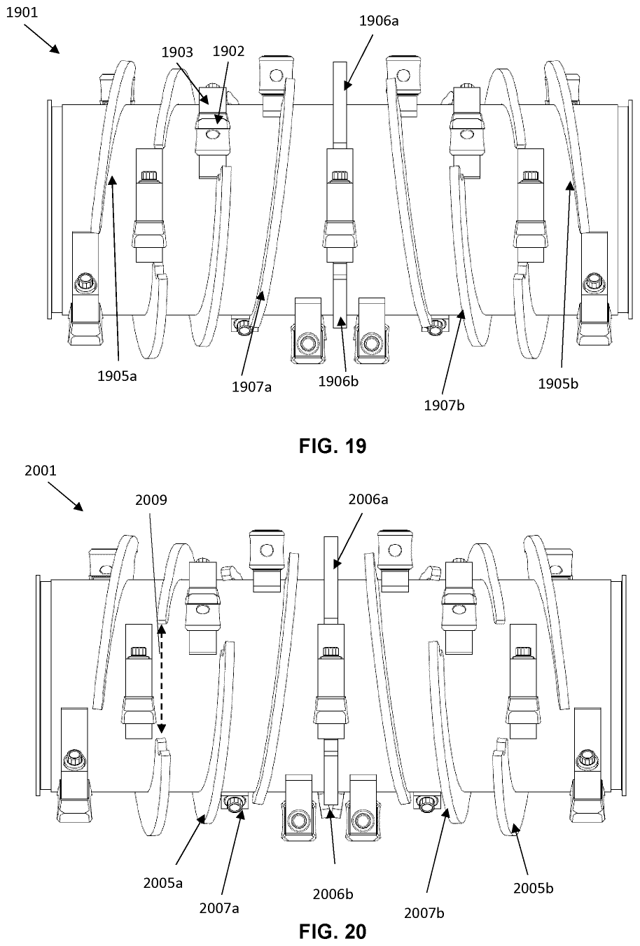

Referring now to FIG. 19, a cutting drum 1901 according to another embodiment is shown. The cutting drum 1901 comprises a plurality of tool holders 1902 configured to hold a cutting tool 1903 and a bite limiter assembly coupled to a curved outer surface of the cutting drum 1901. The bite limiter assembly comprises first minor guide plates 1905a and first major guide plates 1907a on a first side of the cutting drum 1901 that form a first single helix configuration and second minor guide plates 1905b and second major guide plates 1907b coupled on a second side of the cutting drum 1901 that form a second single helix configuration having an opposing chirality to the first single helix configuration. Accordingly, the plurality of tool holders 1902 and the guide plates 1905a, 1905b, 1907a, 1907b are coupled to the curved outer surface of the cutting drum 1901 in a single helix configuration that reverses chirality near an axial center of the cutting drum 1901. In the exemplary embodiment, the bite limiter assembly further includes a major center plate 1906a and a minor center plate 1906b that are coupled to the cutting drum 1901 in an orientation that is substantially perpendicular to the axis of rotation of the cutting drum 1901.

The first and second minor guide plates 1905a, 1905b are aligned helically with a respective one of the first and second major guide plates 1907a, 1907b and are separated by one of the plurality of tool holders 1902 with a cutting tool 1903. In the exemplary embodiment, some of the tool holders 1902 are offset or mis-aligned from a respective guide plate, such that the respective guide plates are positioned off center of the leading end or the trailing end of the respective tool holder 1902 (i.e., on a lateral side thereof).

Referring now to FIG. 20, a cutting drum 2001 according to another embodiment is shown. The cutting drum 2001 comprises a plurality of tool holders 2002 configured to hold a cutting tool 2003 and a bite limiter assembly coupled to a curved outer surface of the cutting drum 2001. The bite limiter assembly comprises a plurality of first guide plates 2005a, 2007a and second guide plates 2005b, 2007b that are coupled to an outer surface of the cutting drum 2001 in a first helix configuration and a second helix configuration, respectively. The first and second helix configurations reverse chirality near an axial center of the cutting drum 2001. In the exemplary embodiment, the bite limiter assembly further includes a major center plate 2006a and a minor center plate 2006b near the axial center of the cutting drum 2001 that separate the first helix configuration from the second helix configuration.

In this embodiment, the first guide plates 2005a, 2007a and second guide plates 2005b, 2007b are each helically aligned with each other (i.e., first guide plate 2005a being helically aligned with first guide plate 2007a and second guide plate 2005b being helically aligned with second guide plate 2007b) and are separated by a gap 2009 that substantially extends the length of a cutting tool 2002. In the exemplary embodiment, some of the tool holders 1902 are offset or mis-aligned from a respective guide plate, such that the respective tool holders are positioned on a lateral side of the gap 2009.

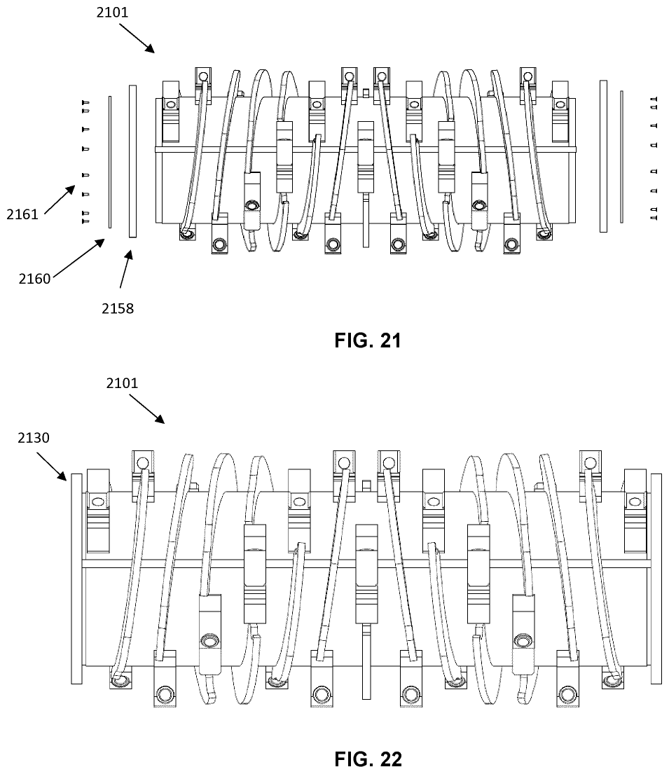

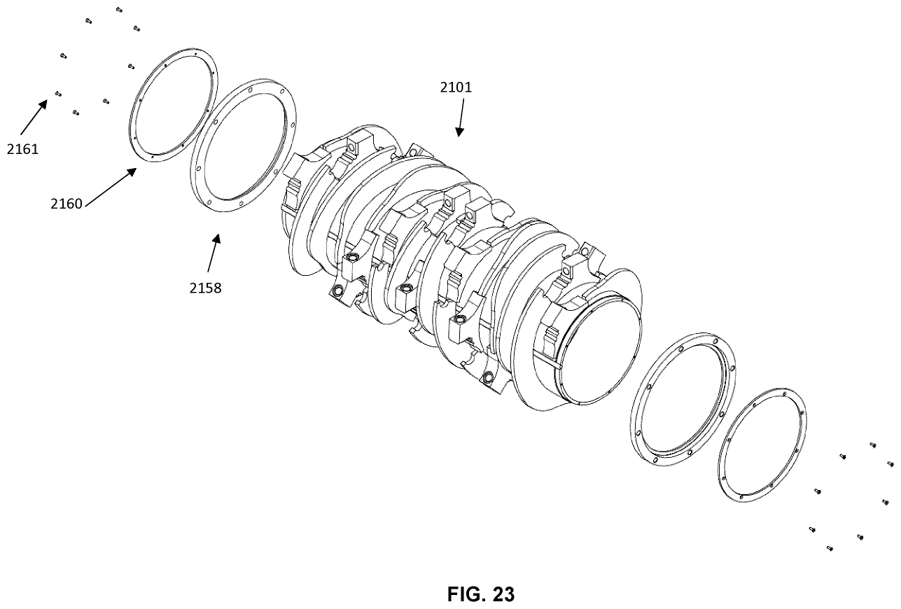

Referring now to FIGS. 21 to 23, a cutting drum 2101 having a debris guard 2130 according to another embodiment is shown. The debris guard 2130 on the terminal ends of the cutting drum 2101 that comprises concentric interlocking rings and grooves of alternate sizes to prevent shredded material of a given size from entering the hollow interior of the cutting drum 2101.

The debris guard 2130 can include a groove (not shown) at each end of the cutting drum 2101 that is configured to receive a grooved plate 2158 that is coupled to the frame of the mulcher head with known coupling means, such as fasteners 2161 or a welded joint. In the exemplary embodiment, the grooved plate 2158 comprises a on-piece circular grooved plate with holes configured to receive the fasteners 2161. The grooved plate 2158 comprises a groove and a protrusion that is configured to fit in the groove of the cutting drum 2101, while still allowing the cutting drum 2101 to freely rotate.

The debris guard 2130 further comprises a ring 2160 that is rotationally coupled to the frame of the mulcher head. The ring 2160 is concentric to the rotational axis of the cutting drum 2101 and is configured to rotate with the cutting drum 2101. The ring 2160 has an exterior diameter that is slightly larger than the exterior diameter of the cutting drum 2101 and an interior diameter of the ring 2160 that is slightly smaller than the exterior diameter of the groove in the cutting drum 2101. The inner diameter of the groove in the grooved plate 2158 is slightly larger than the exterior diameter of the ring 2160, thus preventing shredded material from passing the grooved plate 2158 and entering the interior of the cutting drum 2101.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A mulcher head for shredding a material, the mulcher head comprising:
a frame;
a cutting drum rotationally connected to the frame, wherein the cutting drum comprises;
a tubular body having an axial center, a first side and a second side;
a plurality of tool holders each configured to receive one of a plurality of cutting tools with at least one edge for shredding the material, the plurality of tool holders operatively coupled to an outer surface of the tubular body; and
a bite limiter assembly operatively coupled to the outer surface of the tubular body;
wherein the bite limiter assembly comprises at least one guide plate coupled to the tubular body at an angle to a rotational axis of the cutting drum;
wherein a cutting radius extending from the axis of the cutting drum to a cutting edge of the plurality of cutting tools is greater than a guide radius extending from the axis to an exterior edge of the bite limiter assembly, such that the bite limiter assembly is configured to restrict engagement of each of the plurality of cutting tools with the material.

2. The mulcher head of claim 1, wherein the angle to the rotational axis is between about 5° and about 85° and/or wherein at least two adjacent ones of the plurality of tool holders are coupled to the tubular body offset from each other by between about 5° and about 85°.

3. The mulcher head of claim 1, wherein the bite limiter assembly is coupled to the tubular body in a helix configuration, a double helix configuration, a congruent double helix, or an angled configuration.

4. The mulcher head of claim 3, wherein the angle to the rotational axis is a helical angle between about 45° and about 85°.

5. (canceled)

6. The mulcher head of claim 2, wherein the at least one guide plate and the plurality of tool holders are coupled to the tubular body with a pitch and a chirality that is substantially the same.

7. The mulcher head of claim 1, wherein one of:
the at least one guide plate comprises a plurality of first guide plates forming a first helix on the first side of the tubular body and a plurality of second guide plates forming a second helix on the second side of the tubular body; and
wherein the bite limiter assembly comprises a first guide plate and a second guide plate forming a first double helix on the first side of the tubular body and a third guide plate and a fourth guide plate forming a second double helix on the second side of the tubular body.

8. The mulcher head of claim 7, wherein the plurality of first guide plates and the plurality of second guide plates each comprise at least one major guide plate and at least one minor guide plate.

9. The mulcher head of claim 7, wherein a first chirality of the first helix is the opposite to a second chirality of the second helix.

10. The mulcher head of claim 7, wherein the at least one guide plate further comprises a center guide plate coupled to the tubular body at or near the center axis substantially parallel with the center axis.

11. (canceled)

12. (canceled)

13. The mulcher of claim 7, wherein the at least one guide plate further comprises a first connection plate and a second connection plate, wherein the first guide plate and the third guide plate are coupled at respective ends thereof to the first connection plate and the second guide plate and the fourth guide plate are coupled at respective ends thereof to the second connection plate.

14. The mulcher head of claim 7, wherein a first chirality of the first double helix is the opposite to a second chirality of the second double helix.

15. The mulcher of claim 1, wherein the at least one guide plate is configured to orient a shredded material one of:
towards the first side of the cutting drum;
towards the second side of the cutting drum;
towards the axial center of the cutting drum; or
toward the first side and the second side of the cutting drum.

16. The mulcher head of claim 1, wherein the bite limiter assembly is coupled to the outer surface of the cutting drum between adjacent ones of the plurality of teeth holders or wherein the at least one guide plate is a plurality of guide plates and at least some of the plurality of tool holders are coupled to the outer surface of the cutting drum between abutting ones of the plurality of guide plates.

17. (canceled)

18. (canceled)

19. (canceled)

20. The mulcher head of claim 1, wherein a trailing end of a respective one of the plurality of guide plates comprises a debris recess configured to create a debris release area with a respective one of the plurality of cutting tools when fastened in a respective one of the plurality of tool holders.

21. The mulcher head of claim 1, wherein the cutting drum further comprises a first mounting plate coupled to the tubular body on the first side and a second mounting plate coupled to the tubular body on the second side, the first mounting plate having a first coupling interface for operatively connecting with a first rotational shaft and the second mounting plate having a second coupling interface for operatively connecting with a second rotational shaft, wherein a first axial distance between the axial center and the first mounting plate is larger than a second axial distance between the axial center and the second mounting plate and wherein the second mounting plate is coupled to an interior wall of the tubular body between the axial center and a second end of the tubular body on the second side to create a cavity within a hollow interior of the tubular body.

22. (canceled)

23. The mulcher head of claim 21, further comprising at least one of:
a mounting flange operatively coupled to the second rotational shaft in the cavity for securing a motor in the cavity; and
a debris guard on the cutting drum, the debris guard comprising a first groove on a first end of the first side and a second groove on a second end of the second side.

24. (canceled)

25. The mulcher head of claim 23, wherein the debris guard comprises a first grooved plate coupled to the frame adjacent to the first end of the tubular body and a second grooved plate coupled to the frame adjacent to the second end of the tubular body, wherein the first grooved plate and the second grooved plate each comprise a groove and a protrusion, and wherein the first groove is configured to receive the protrusion of the first grooved plate and the second groove is configured to receive the protrusion of the second grooved plate.

26. The mulcher of claim 25, wherein an inner diameter of the protrusion of the first grooved plate and the second grooved plate is larger than an exterior diameter of the first groove and the second groove or wherein the debris guard further comprises a first ring coupled to the first mounting plate and a second ring coupled to the second mounting plate; wherein the first ring and the second ring each have an exterior ring diameter that is larger than an exterior diameter of the tubular body.

27. (canceled)

28. The mulcher head of claim 26, wherein an inner diameter of the groove of the first grooved plate and the second grooved plate is larger than the exterior ring diameter of the first ring and the second ring and/or wherein an interior ring diameter of the first ring and the second ring is larger than an interior diameter of the tubular body.

29. (canceled)

30. A cutting drum configured to mount onto a frame for shredding a material, the cutting drum comprising:
a tubular body having an axial center, a first side and a second side;
a plurality of tool holders each configured to receive one of a plurality of cutter tools with at least one edge for shredding the material, the plurality of tool holders operatively coupled to an outer surface of the tubular body; and
a bite limiter assembly operatively coupled to the outer surface of the tubular body;
wherein the bite limiter assembly is coupled to the tubular body in a helix configuration; and
wherein the bite guard assembly is configured to restrict a depth of engagement of each of the plurality of cutting tools with the material.

31. (canceled)
